(19) United States
(12) Patent Application Publication
(10) Pub. No.: US 2019/0102371 A1
(43) Pub. Date: Apr. 4, 2019

(54) IMMIGRATION DATA MANAGEMENT

(71) Applicant: Tracker Corp, San Francisco, CA (US)

(72) Inventors: Hendrik Pretorius, San Francisco, CA (US); Lorri Leon, San Francisco, CA (US); Karnig Takvorian, San Francisco, CA (US)

(73) Assignee: Tracker Corp, San Francisco, CA (US)

(21) Appl. No.: 15/720,287

(22) Filed: Sep. 29, 2017

(51) Int. Cl. G06F 17/24; G06Q 50/26; G06N 99/00

(52) U.S. Cl. CPC G06F 17/243; G06N 99/005; G06Q 50/26; G06F 17/248

(57) ABSTRACT

Described herein are techniques and mechanisms for immigration data management. According to various embodiments, an immigration application template may be created by identifying draft filing that each correspond with one or more pages of an immigration application and that each identify information to be included in an immigration application. The draft filing types may be ordered and the template may be stored in a storage medium. The template may be combined with information retrieved from a database or other source to produce a draft immigration application.

### TECHNICAL FIELD

The present disclosure relates generally to computer systems configured to assist in the automatic and/or dynamic construction of legal case submissions including government forms, legal briefs, and supporting evidence based on predefined templates.

### DESCRIPTION OF RELATED ART

Various documents and forms may be used to record and present information necessary for submitting applications, such as applications to government entities. For example, an H-1B application for a non-immigrant worker typically includes many different documents such as an I-129 government form, a G-28 attorney representative form, supporting documentation providing evidence of education and professional certifications, an attorney cover letter and support letter (legal brief), and a signature page.

Preparing certain types of applications, such as immigration applications, typically requires organizing a substantial amount of information in order to meet government requirements. Such information may include form fields, signatures, and unstructured documents. Managing this complexity presents significant administrative and technical hurdles for companies, and errors can lead to delays or denied applications. Accordingly, new techniques and mechanisms for assisting in the management of immigration data and the preparation and submission of immigration applications are desired.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide methods, devices, and machine-readable media for creating an immigration application template. According to various embodiments, a request to create an immigration application template corresponding with a designated immigration application type may be received. A plurality of draft filing types to include in the immigration application template may be identified, where each draft filing type corresponds with a respective one or more pages of an immigration application and each draft filing type identifys information to be included in the immigration application. Ordering information for the identified draft filing types may be determined, and the immigration application template may be stored on a storage medium. The ordering information may indicate an order in which information corresponding with the identified draft filing types is included in the immigration application.

In particular embodiments, a first one of the draft filing types corresponds to an official immigration form provided by the United States Citizenship and Immigration Service. The draft filing type may indicate one or more information fields for providing information used to complete the official immigration form. In addition, the draft filing type may also indicate a respective database location for one or more of the indicated information fields, where the database location stores information suitable for filling the indicated information field.

In particular embodiments, the immigration application template may include a designated review criterion that indicates one or more reviewers to review the immigration application created based on the template. The reviewer may include a machine learning procedure configured to estimate a probability of success for the immigration application. The machine learning procedure may be further configured to identify one or more characteristics of the immigration application to be modified in order to increase the probability of success.

According to various embodiments, a first one of the draft filing types may correspond to a type of supporting document to be included in the immigration application. The supporting document may include one or more data fields that may be filled based on user input.

In particular embodiments, a business logic rule to resolve one or more potential errors that may occur when creating the immigration application based on the template may be identified. The business logic rule may indicate a criterion for identifying an error condition. The business logic rule may also indicate a procedure for correcting the identified error condition.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates an example of an immigration application creation overview procedure, performed in accordance with one or more embodiments.

FIG. 2 illustrates an example of an immigration application template creation procedure.

FIG. 3 illustrates an example of an immigration application template, configured in accordance with one or more embodiments.

FIG. 4 illustrates an example of an immigration application creation procedure.

FIG. 5 illustrates an example of an immigration application review procedure.

FIG. 6 illustrates one example of a server, configured in accordance with one or more embodiments.

FIGS. 7-15 illustrate various user interfaces that may be presented in accordance with techniques and mechanisms described herein.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, some of the techniques of the present invention will be described in the context of United States (US) immigration application forms. However, it should be noted that the techniques of the present invention apply to a wide variety of different documents and communications. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Many companies submit a variety of types of applications for government review. A commonly submitted application type is an immigration application, of which there are many varieties. Immigration applications are typically many pages in length and include many different types of documents such as government forms, unstructured evidentiary documents, cover letters, and signature pages.

The creation of immigration applications often involves information drawn from potentially many different sources. For example, different individuals may provide document drafts. As another example, information may be retrieved from a database or other repository. As yet another example, individuals may provide free-form text responses.

The creation of immigration applications often involves the participation of many different individuals. For example, an attorney or other legal practitioner may specify the characteristics of an immigration application. Then, an administrator may supply much of the information necessary for the application. Next, parties such as a supervisor or application subject may submit supporting documentary evidence. Finally, various parties may review and sign the completed application.

Managing the process for the creation of an immigration application presents a significant technical problem for businesses. A business must ensure that an immigration application meets the technical requirements associated therewith while at the same time organizing information received from a variety of sources and from a variety of parties while doing so as efficiently as possible.

According to various embodiments, techniques and mechanisms described herein facilitate the creation of immigration applications that meet government requirements. These techniques and mechanisms may provide for the improved efficiency of computing systems that manage immigration application data.

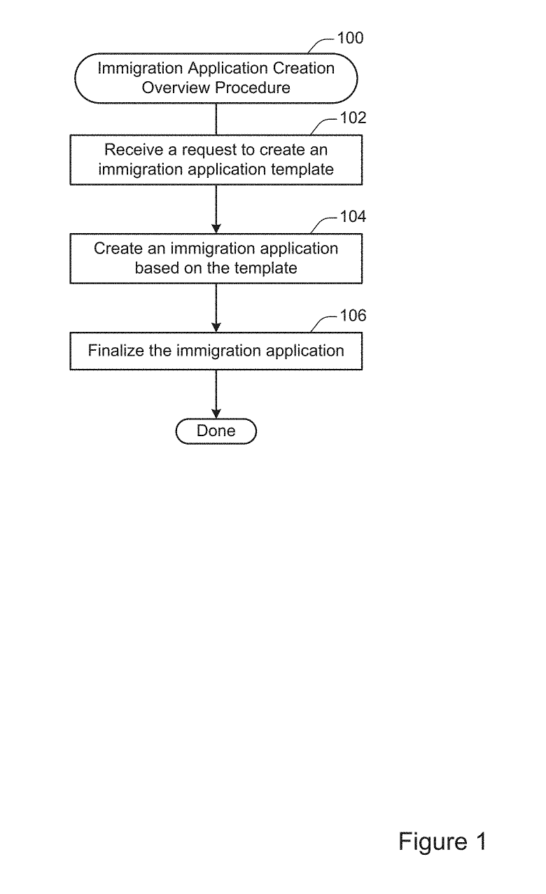

FIG. 1 illustrates an immigration application overview procedure 100, performed in accordance with one or more embodiments. According to various embodiments, the procedure 100 may be performed in order to facilitate the creation of one or more immigration templates and the creation of one or more immigration applications based on a template. In some implementations, the procedure 100 may be performed at a server in communication with a client machine. Alternately, the procedure 100 may be performed entirely at a client machine. As an overview, an immigration template is created at 102. Then, at 104, an immigration application based on a template or a combination of templates is created. Finally, the immigration application is reviewed by, for example, the sponsoring organization and finalized at 106.

At 102, an immigration template is created. In some implementations, creating an immigration template may involve identifying information to be provided and ordered to create an immigration application. For example, creating the immigration template may involve adding or selecting one or more immigration forms. As another example, creating the immigration template may involve identifying a free-form document to be included, such as a supporting recommendation letter or legal brief. In particular embodiments, creating an immigration template may involve indicating an order in which the forms or information are to be organized.

According to various embodiments, a template may be based at least in part on one or more pre-existing government application forms, such as an H-1B visa transfer being prepared using an 1-129 form provided by the United States Citizenship and Immigration Services (USCIS). Alternately, or additionally, a custom template may be created based at least in part on customized application information, such as a custom template for a letter of reference to support an immigration application.

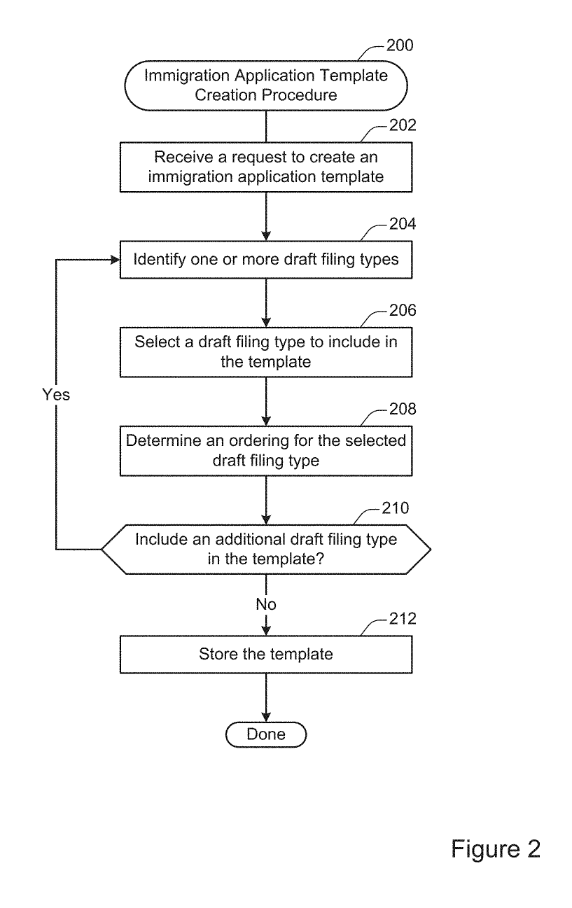

In some embodiments, a template may be based both on customized application inputs and on one or more pre-existing application forms. For example, in the case of an I-140 Immigrant Petition for Alien Worker, which is one piece of the overall employment-based Green Card process, a template can be based in part on pulling in the certified government foreign labor certification form ETA-9089 along with the Form I-140, which are standard governmental forms including fields for information submitted by the sponsoring organization. In addition, the template may include one or more custom components, such as fields for signatures of the company's representatives. A template can also include one or more custom components for assembling supplemental documentation on the part of the organization sponsoring a visa application. For example, a template may include one or more custom components for letters of reference supporting the sponsored individual's position qualifications and past work experience. Some other examples of documents often included in such an application are University degrees and transcripts, employee paystubs, company financial documents and so forth. Techniques for creating an immigration template are discussed in further detail with respect to FIG. 2.

At 104, an immigration application is created based on an immigration template or a combination of immigration templates. According to various embodiments, the information necessary to complete a template may be identified via methods which may include, but are not limited to, user input or an automated detection process. For example, the information identified as necessary to complete the template may include blank fields. As another example, the information identified as necessary to complete the template may include documents in a digital format such as letters of reference. The administrative user may lock draft filing document types as a way to force users to include such documents in the application. Alternatively, once the draft filing is created based on the identified draft filing document types being pulled into the template in the order provided in the draft filing template, a user may still reorder or add new documents and exhibits tabs on-the-fly.

According to various embodiments, the information required to complete the fields of a template may include user input. For example, a user may be prompted to submit information necessary to complete the template, such as information entered into a blank text field or other form component. As another example, a user may be prompted to provide a document. As yet another example, the user may be prompted to provide a signature via a pen input, a scanned signature page, or other technique.

In particular embodiments, the template may be populated by pulling documents, immigration forms, and other information from data that has already been collected within the system prior to creating a case draft. After the case draft is created from pulling in items to complete the template, a user such as a paralegal can reorder items, add exhibits, and perform other actions as long as the file or template is not locked. When documents are pulled into the template, an “edit online” feature may allow the user to make changes to the document and then save it directly into the case draft.

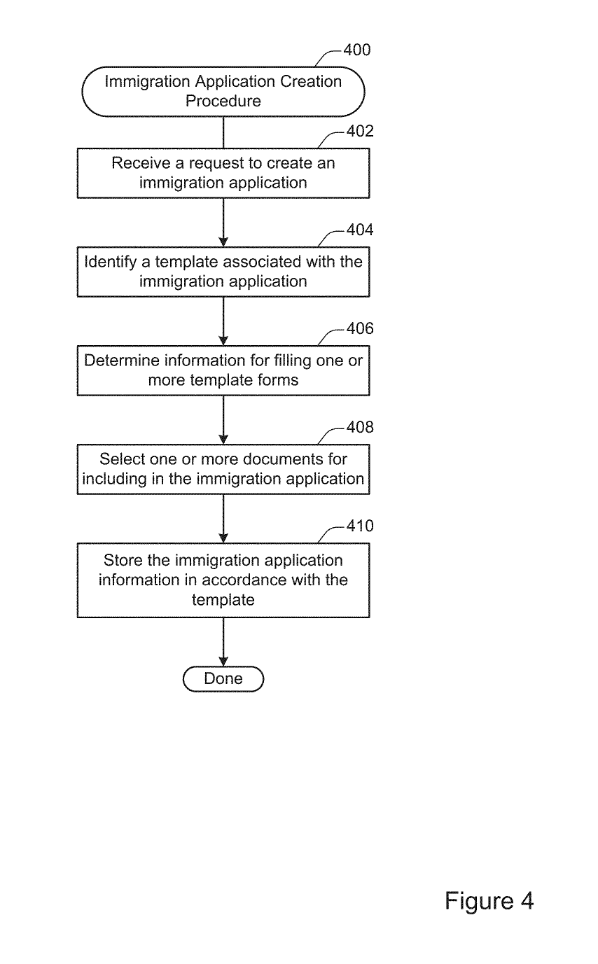

At 106, the immigration application is finalized. According to various embodiments, finalizing the immigration application may involve submitting the application for review by one or more reviewers. Such reviewers may include, but are not limited to: an automated review process, one or more attorneys, one or more sponsoring organization representatives, and one or more third party reviewers. As part of the review process, one or more errors or omissions may be identified and corrected. For example, errors may be corrected via business logic. As another example, errors may be corrected by prompting a user to supply missing or erroneous information. After the immigration application is finalized, it may be stored on the system for file retention, retrieval, or electronic submission. Alternately, or additionally, the immigration application may be printed for physical submission or transmitted to a client machine. Techniques for finalizing an immigration application are discussed in further detail with respect to FIG. 4.

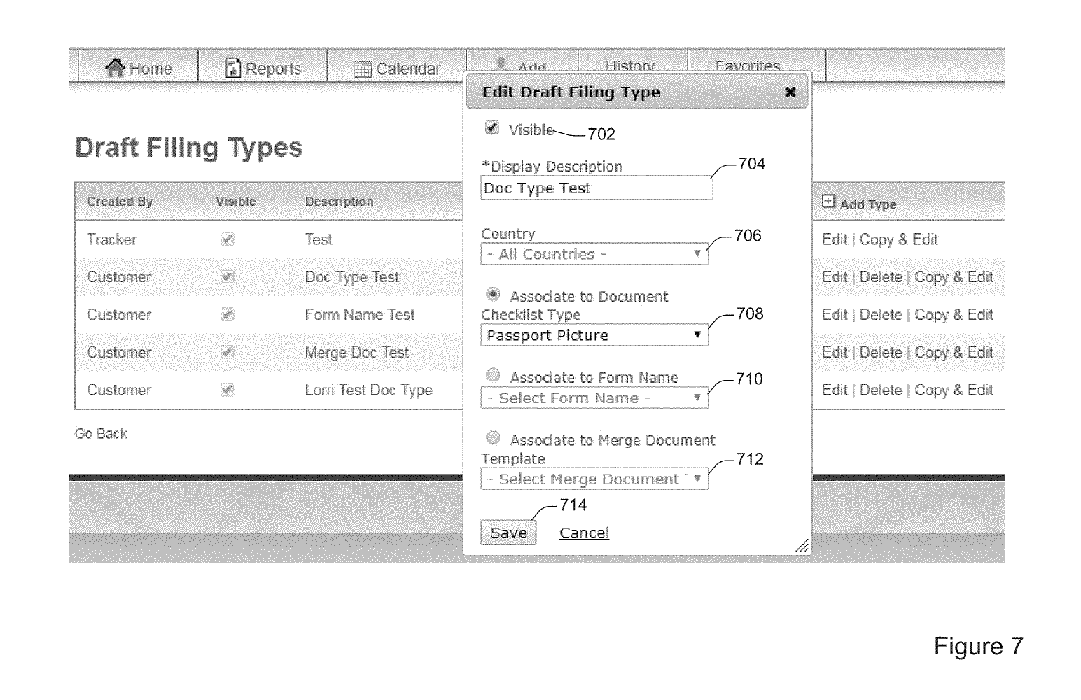

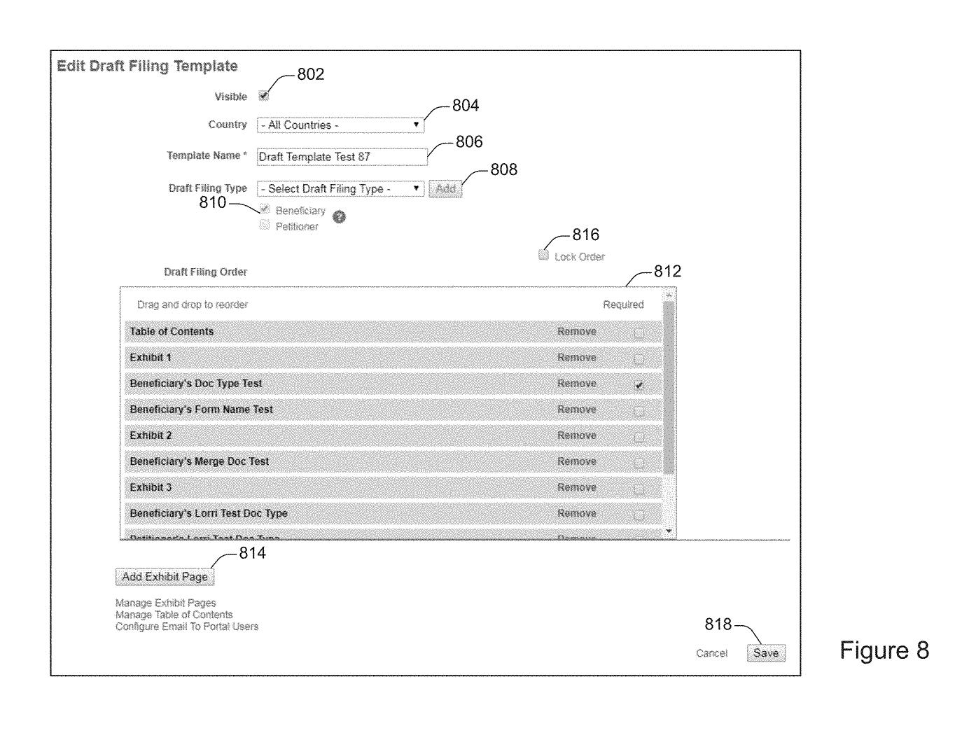

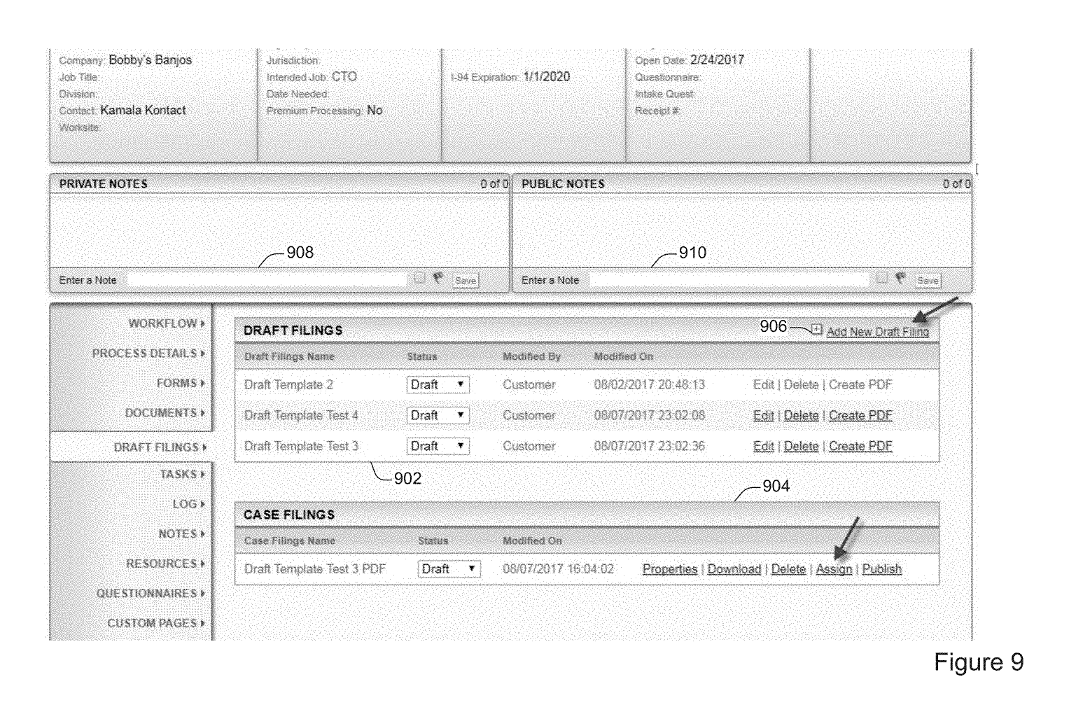

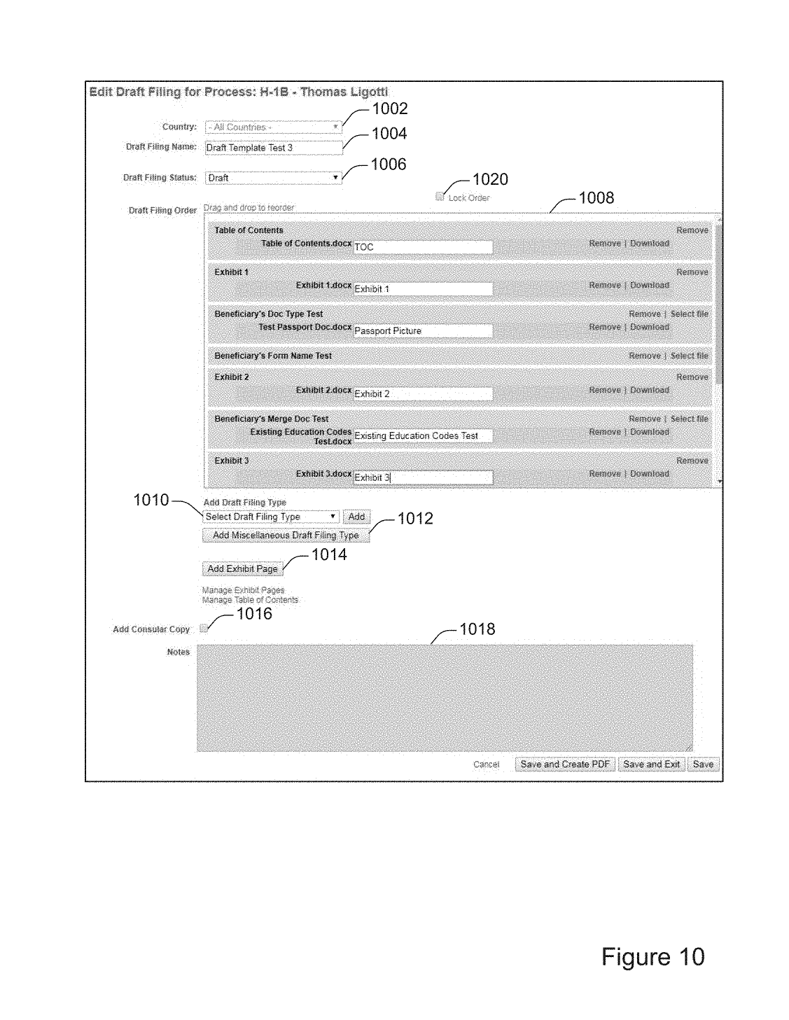

FIGS. 7-10 illustrate examples of user interfaces for creating, editing, selecting, or determining the order of draft filing types to include in an immigration application template, in this case an H-1B visa application. FIG. 7 shows a user interface that facilitates creation or editing of a draft filing type, configured in accordance with one or more embodiments. FIG. 8 shows a user interface that facilitates the creation or editing of an immigration application template. FIG. 9 shows a user interface that displays draft filings based on templates and completed immigration filings. FIG. 10 shows a user interface that facilitates the selection and ordering of draft filing templates to include in an immigration application draft filing. FIGS. 7-10 are discussed in additional detail in reference to FIGS. 2, 3, 4, and 5.

FIG. 2 illustrates an example of an immigration application template creation procedure 200, performed in accordance with one or more embodiments. According to various embodiments, the procedure 200 may be performed in order to facilitate the creation of an immigration application template based on one or more draft filing types. In some implementations, the procedure 200 may be performed at a server in communication with a client machine. Alternately, the procedure 200 may be performed entirely at a client machine.

As an overview, a request to create an immigration application template is received at 202. Then, at 204, draft filing types are identified. At 206, a determination of a draft filing type to include in a template is made. At 208, a determination of the ordering of the draft filing types included in the immigration application template is made. At 210, the immigration application template is reviewed and finalized. Finally, the immigration application template is stored at 212.

According to various embodiments, the procedure 200 may be performed in order to facilitate the creation of an immigration application template based on one or more draft filing types. In some implementations, the procedure 200 may be performed at a server in communication with a client machine. Alternately, the procedure 200 may be performed entirely at a client machine.

At 202, a request to create an immigration application template is received. According to various embodiments, the request may be created based on user input that indicates a request to create a new type of immigration application template. Alternately, or additionally, a request may be created automatically or dynamically, such as when the system detects the presence of a new type of immigration application.

At 204, one or more draft filing types associated with the immigration application are identified. According to various embodiments, a draft filing type can be associated with a government form. Alternately or additionally a draft filing type may be associated with a pre-existing document stored on a storage device, or a custom template.

In some implementations, draft filing types may be associated with specific government immigration forms. For example, for an H-1B immigration application, a draft filing type may be a government form such as an I-129 petition for a non-immigrant worker. As another example, for an I-140 employment based Green Card application, a draft filing type may be the certified PERM application and I-140 Immigration Petition for Alien Worker immigration form.

In particular embodiments, draft filing types may include a merged document templates, for example an immigration application cover letter by the employer sponsor or attorney representative. In some instances, this draft filing type may be created through a merged document process, which may include methods of document creation including, but not limited to, merging user information provided in a blank text field with a pre-existing template.

In some embodiments, a draft filing type may be based on customized application inputs, on one or more pre-existing application forms, or on some combination thereof. For example, a draft filing type may include a blank or partially filled government form. As another example, a draft filing type may include a user submitted document, such as a copy of a diploma or an employment offer letter.

According to various embodiments, a draft filing type may be identified by user input, an automated process, or some combination thereof. In some implementations, a user may identify a document to associate with an immigration application, such as a particular supporting document such as a professional certification. Alternately or additionally, an automated process may identify specific draft filing types to include in an immigration application. For example, for an H-1B visa application, an automated process may determine that the draft filing types based on forms such as an I-129 Petition for a Nonimmigrant Worker are required. Alternately or additionally an automated process may determine that for an H-1B visa application, the optional form I-907 should be suggested to a user to include in an application.

FIG. 7 shows a user interface that facilitates creation or editing of a draft filing type, configured in accordance with one or more embodiments. FIG. 7 also includes various user interface components for receiving information associated with a draft filing type.

At 702, a user may select the visibility level for a draft filing type, for example by checking a box to make the draft filing type visible to others with access to the system. At 704, a user may provide information regarding the description to display for the draft filing type by providing text in one or more blank fields. At 706, a user may provide information associated with a particular draft filing type by making a selection from a drop-down menu, such as a selection of a country to associate with the draft filing type.

At 708, a user may associate a draft filing type to a particular document list type by selecting a document type from a drop-down menu, for example a United States passport. At 710, a user may associate a draft filing type with a particular government form by selecting a form type with a with a merge document template from a drop-down menu selection. At 712, a user may associate a draft filing type to a merge document template by selecting a merge document from a drop-down menu selection. Finally, at 714, a user may save the draft filing type.

Returning to FIG. 2, at 206 a draft filing type to include in a template is selected. According to various embodiments, an immigration application template may include one or more draft filing types. For example, an immigration application for an H-1B employer based petition may include draft filing types including, but not limited to, a merged document cover letter, an employment offer letter, a user submitted Labor Certification Application approval notice from the United States Department of Labor, and a draft filing type based on the USCIS government form I-129 Petition for a Nonimmigrant Worker.

According to various embodiments, a draft filing type may be selected based on user input, an automated process, or some combination thereof. In some implementations, a user may select a draft filing type to associate with an immigration application, such as a particular supporting document such as a diploma. Alternately or additionally, an automated process may identify specific draft filing types to include in an immigration application based on the definition of immigration application. For example, for an H-1B visa application, an automated process may select a draft filing type based on the required form I-129 Petition for a Nonimmigrant Worker are required. Alternately or additionally, for an H-1B visa application, an automated process may select a cover letter draft filing type to include in the application. In some implementations, the automated process may prompt the user to provide information in one or more blank text fields to create a merged document based on a cover letter template.

FIG. 8 illustrates an example of a user interface that facilitates the creation or editing of an immigration application template. FIG. 8 also includes various user interface components for receiving information associated with a draft filing template.

At 802, a user may select the visibility level for a draft filing type, for example by checking a box to make the draft filing template visible to others with access to the system. At 804, a user may provide information associated with a particular draft filing template by making a selection from a drop-down menu, such as a selection of a country to associate with the draft filing type. At 806, a user may provide information regarding the template name to display for the draft filing type by providing text in one or more blank fields. At 808, a user may select a draft filing type to add to the draft filing template from a drop-down menu. Alternately and additionally, the user may add a new draft filing type to add to the draft filing template. At 810, a user may select a role to be associated with a draft filing template, for example, a petitioner employee, or a beneficiary employer sponsor.

Returning to FIG. 2, at 208 an ordering for the draft filing types is determined. According to various embodiments, an immigration application template may include one or more draft filing types to be submitted in a particular order. For example, an H-1B employer based petition may be arranged in a particular order, beginning with a filing fee page, which may be followed by form I-907 if filing for premium processing, which may be followed by form G-28 if represented by an attorney, which may be followed by form 1-129 Petition for a Nonimmigrant Worker, and which may then be followed by supporting documentation such as evidence of petitioner's education, and other supporting documents.

According to various embodiments, the ordering of the draft filing types may be identified based on user input, an automated process, or some combination thereof. In some implementations, a user may provide information on the order of draft filing types through user inputs such as a drag and drop method or by providing information such as ordinal numbers in a blank text field. Alternately or additionally, an automated process may determine the order of draft filing types to include in an immigration application. For example, for an H-1B visa application, an automated process may determine that the I-129 Petition for a Nonimmigrant Worker will precede any supporting documentation for the I-29. In particular implementations, a combination of an automated-process and user input will determine the order, for example an automated system may suggest an order for the draft filing types, and a user may accept, decline, or edit the proposed order.

In the example of a user interface shown in FIG. 8, at 812 a user may re-order the draft filing types in a draft filing template via a drag-and-drop method.

Returning to FIG. 2, at 210 a determination is made as to whether to include an additional draft filing type in the template. According to various embodiments, the determination may be based at least in part upon user input. For example, a user may indicate a request to include an additional draft filing type. Alternately, or additionally, the determination may be based at least in part automatically or dynamically. For example, the system may identify one or more draft filing types to be included in particular application templates and indicate that an additional filing type is needed if not currently present in the template.

In the example of a user interface shown in FIG. 8, at 814 a user may add an additional exhibit page, for example supporting documentation regarding the petitioner employee's professional certifications.

Returning to FIG. 2, at 212 the immigration application template is stored. According to various embodiments, the template may be stored in a data storage system such as a database. After the immigration application template is finalized, it may be stored on the system for file retention, retrieval, or electronic submission. The template may be stored in such a way that it may be retrieved, for instance in the event that the template may be reused in a separate immigration application. Alternately, or additionally, the immigration application may be printed for physical submission or transmitted to a client machine.

In the example of a user interface shown in FIG. 8, at 816, a user has an option to lock the particular ordering of the draft filing template. At 818, a user may save the draft filing template.

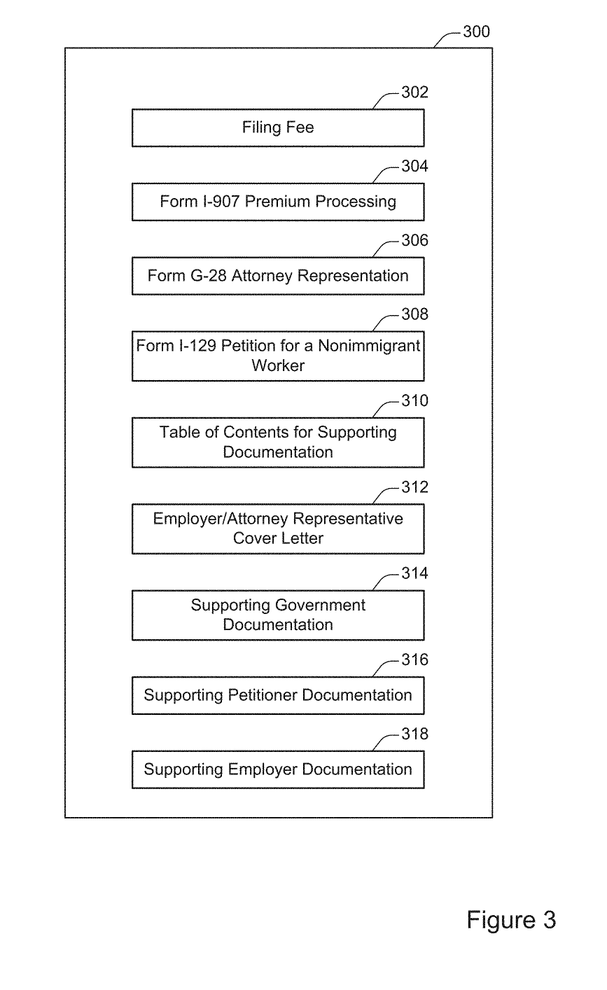

FIG. 3 illustrates an example of an immigration application template 300, configured in accordance with one or more embodiments. According to various embodiments, a template may be associated with one or more immigration application types. For example, a template may be associated with an H-1B visa application for a nonimmigrant worker. As another example, a template may be associated with an O-1 work visa application for individuals with extraordinary ability or achievement.

According to various embodiments, an immigration application template may include required draft filing types. For example, one or more government forms may be required for some types of immigration applications. In some instance, an immigration application template may include optional draft filing types. For example, a cover letter or certain types of supporting documentation may be optional for some types of immigration applications.

In the specific example shown in FIG. 3, the immigration application template 300 is associated with an H-1B visa application. At 302, the immigration application template for an H-1B visa application includes a draft filing type for the required filing fee associated with the H-1B visa application. At 304, the immigration application template includes an optional draft filing type based on USCIS Form I-907, to be included if the employer sponsor wishes to file the application with premium processing. At 306, the immigration application template includes an optional draft filing type based on USCIS Form G-28, to be included if the application is filed by an attorney representative for the employer sponsor. At 308, the immigration application template includes a draft filing type based on the government required Form I-129 Petition for a Nonimmigrant Worker.

At 310, a draft filing type for an optional table of contents for supporting documentation is shown. In some embodiments, a draft filing type for a table of contents may be created based at least in part on user input. Alternately or additionally, a table of contents may be created at least in part through an automated process.

At 312, a draft filing type for an employer or attorney representative cover letter is shown. In some embodiments, the cover letter may be created by a user. Alternately or additionally, a cover letter may be created by an automated process to create a merged document from information such as a blank form and data retrieved from a database.

At 314, a draft filing type for supporting government documentation for the immigration application template by a petitioner employee is shown. For example, the petitioner employee may include supporting documentation such as a I-797 approval notice. As another example, the petitioner employee may include supporting documentation such as an I-94 arrival-departure record.

At 316, a draft filing type for supporting petitioner documentation for the immigration application template is shown. For example, the petitioner employee may include supporting documentation such as copies of the petitioner's diplomas. As another example, the petitioner employee may include supporting documentation such as evidence of the petitioner's professional certifications.

At 318, a draft filing type for supporting employer documentation for the immigration application template is shown. For example, the employer sponsor may include supporting documentation such as a copy of the employment agreement letter between the employer sponsor and the petitioner employee.

FIG. 4 illustrates an example of an immigration application creation procedure 400, performed in accordance with one or more embodiments. According to various embodiments, the procedure 400 may be performed in order to facilitate the creation of an immigration application based on one or more immigration application templates. For example, the procedure 400 may be performed to facilitate the creation of an H-1B visa application. As another example, the procedure 400 may be performed to facilitate the creation of a PERM application. As yet another example, the procedure 400 may be performed to facilitate the creation of an O-1 visa application. In some implementations, the procedure 400 may be performed at a server in communication with a client machine. Alternately, the procedure 400 may be performed entirely at a client machine.

As an overview, a request to create an immigration application is received at 402. Then, at 404, one or more templates associated with an immigration application are identified. At 406, the information for filling one or more template forms is determined. At 408, one or more documents for including in the immigration application are selected. Finally, 410, the immigration application information is stored in accordance with the template.

At 402, a request to create an immigration application is received. According to various embodiments, the request may be created based on user input that indicates a request to create a new immigration application. Alternately, or additionally, a request may be created automatically or dynamically. For example, a request may be created automatically or dynamically when an employee is hired and labeled with a status such as “requiring H-1B visa transfer. As another example, a request may be created automatically or dynamically through an automated detection process that analyzes the work authorization documents supplied in support of the employee's I-9 verification form.

At 404, a template associated with the immigration application is identified. According to various embodiments, a template may be identified by user input, an automated process, or some combination thereof. For example, a user may identify a custom template to associate with an immigration application, such as an employer sponsor cover letter. As another example, an automated process may identify specific templates to include in an immigration application. For instance, for an H-1B visa application, an automated process may determine that a template based on forms such as an I-129 Petition for a Nonimmigrant Worker is required. As yet another example, an automated process may determine that for an H-1B visa application, a template that includes the I-907 form should be suggested to a user to include in an application. As still another example, an automated process may determine that a template including on the I-129 form is required for an H-1B visa application.

At 406, information for filling one or more template fields is determined. In some implementations, the information for filling a template form may be provided based at least in part on user input. For example, a user may provide text to be entered into a blank text field. As another example, a user may upload a document, such as an employment agreement letter, when prompted to supply supporting documentation.

According to various embodiments, an automated process may provide some or all of the information for filling a template field by retrieving information from any of various data sources such as a database or data storage medium. For example, the information for filling a template field may be retrieved from one or more pre-existing documents such as an I-9 form.

As another example, the information for a template may be retrieved from an employment database.

In some implementations, business logic may be used to determine the information for filling one or more template forms. For example, an automated process may determine that a particular government form is identified with a corresponding government agency, and may provide that particular government agency's name in an associated text field or template. For instance, the Labor Certification Approval is a supporting document for a H-1B visa application, and is received by a sponsoring employer from the Department of Labor. In this case, an automated process can determine that the Department of Labor is the correct government agency to associate with that particular document, for the purposes of adding that document to a template such as a table of contents for a H-1B visa application.

At 408, one or more documents for including in the application are selected. According to various embodiments, a document may be selected by user input, an automated process, or some combination thereof. For example, a user may select a document to associate with an immigration application, such as a professional certification. As another example, an automated process may identify a document to include in an immigration application based on the template definition. For instance, for an H-1B visa application, an automated process may select a copy of a required document such as a completed I-129 form.

In particular embodiments, operation 408 may be omitted. For example, once a template is selected for the creation of a particular immigration application, the system may automatically pull in all of the documents that make up the draft filing including government forms, support letters, and other exhibits.

At 410, the immigration application information is stored in accordance with the template. According to various embodiments, the immigration application information may be stored in a data storage system such as a database. After the immigration application information is finalized, it may be stored on the system for file retention, retrieval, or electronic submission. Alternately, or additionally, the immigration application information may be printed for physical submission or transmitted to a client machine.

According to various embodiments, the immigration application information may be stored in such a way that it may be retrieved, for instance in the event that the information may be reused in a separate immigration application. For example, after a petitioner employee's H-1B transfer application has been submitted, the employer sponsor may wish to begin a separate PERM application for the petitioner employee.

FIG. 9 shows a user interface that displays draft filings based on templates and completed immigration filings. FIG. 9 also includes various user interface components for receiving information associated with an immigration application. At 902, a user may edit or remove an immigration application based on a template. At 904, a user may assign an application for review internally or to a third party. Alternately or additionally, a user may download, remove, or publish to be viewed by other users in the system. At 906, a user has an option to add a new immigration application. At 908, a user has an option to provide information in the form of notes that are privately viewable, for example by providing text in one or more blank text fields. At 910, a user has an option to provide information viewable to others, for example by providing text in one more blank text fields.

FIG. 10 illustrates a user interface that facilitates the preparation of an immigration application based on a draft filing template. FIG. 10 also includes various user interface components for receiving information associated with an immigration application. For example, the information may include pre-existing documents stored at a storage medium associated with an individual petitioner's immigration application. As another example, the information may be created and added by a user. As yet another example, the information may be queried from a database or other repository.

At 1002, a user may provide information associated with a particular draft immigration application by making a selection from a drop-down menu, such as a selection of an associated country. At 1004, a user may provide information regarding the draft filing name to display by providing text in one or more blank fields. At 1006, a user may select a draft filing status, for example, “draft,” or as another example, “ready to file.”

At 1008, a user may re-order the draft filing types in the application via a drag-and-drop method. At 1010, a user may add an additional draft filing type to the draft immigration application, for example a draft filing type associated with a particular government form. At 1012, a user may add a miscellaneous draft filing type, for example a custom draft filing type or merged document. At 1014, a user may add an exhibit page, for example an employment agreement. At 1016, a user may add a copy of a government document, for example an I-94 arrival and departure record.

At 1020, a user has an option to lock the particular ordering of the draft immigration application. At 1018, a user has an option to provide information in the form of notes to be associated with the draft immigration application, for example by providing text in one or more blank text fields.

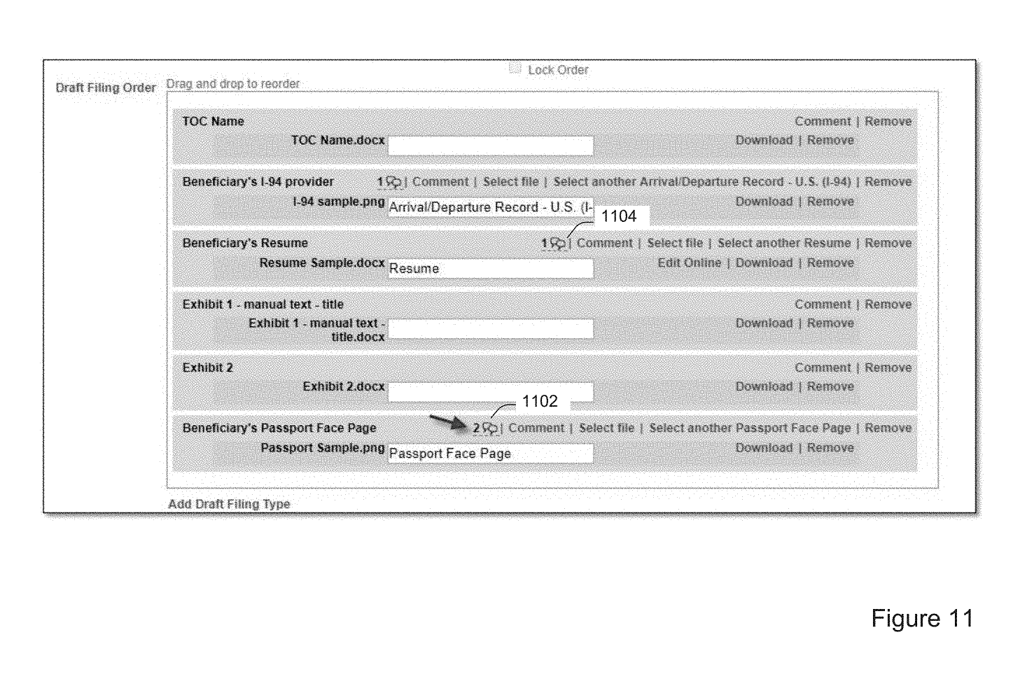

After a draft immigration application is created, it may be subjected to review and commenting. FIGS. 11-15 illustrates examples of various views of a commenting interface, provided in accordance with one or more embodiments. The commenting interface may be provided in order to facilitate the addition of reviewer comments for an immigration application based on an immigration application template.

According to various embodiments, a reviewer may add one or more comments to draft filing items to be included in a particular immigration application. For example, at 1102, the comment icons indicate that a reviewer has added one comment to the item for “Beneficiary's Resume.” At 1104, the comment icons indicate that a reviewer has added two comments to the item “Beneficiary's Passport Face Page.”

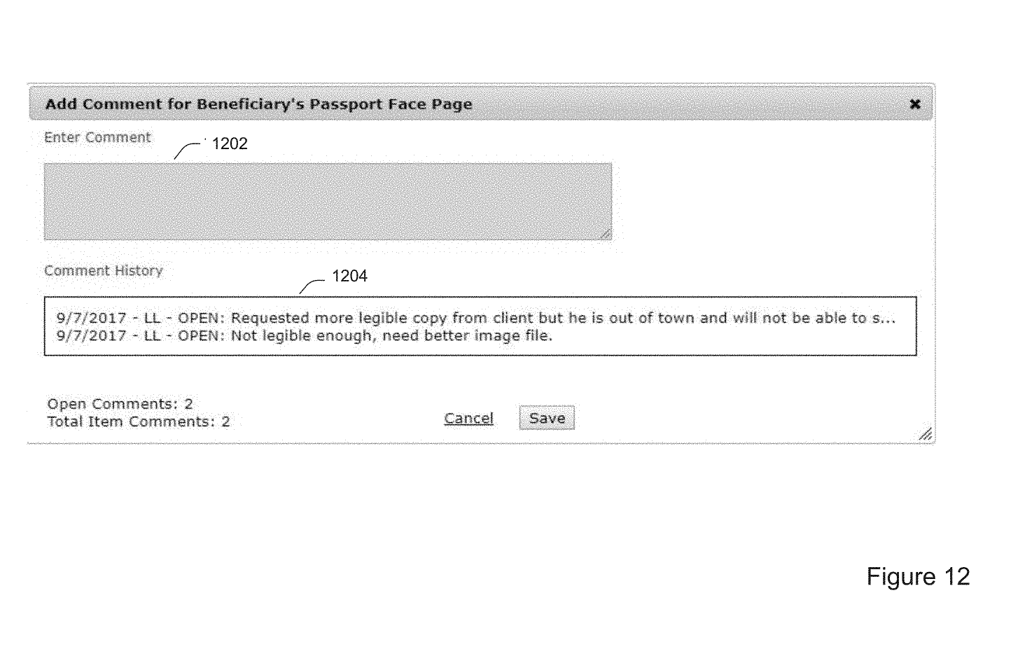

As shown in FIG. 12, a commenting interface may be used to facilitate the submission of reviewer feedback including, but not limited to, comments, notes, or questions. For example, the comment interface may be utilized to collect reviewer feedback on a particular draft filing item associated with a particular immigration application template. At 1202, reviewer feedback is submitted through a text box. At 1204, comment history is displayed for the particular document. In this example, the comment history is associated with the “Beneficiary's Passport Face Page.”

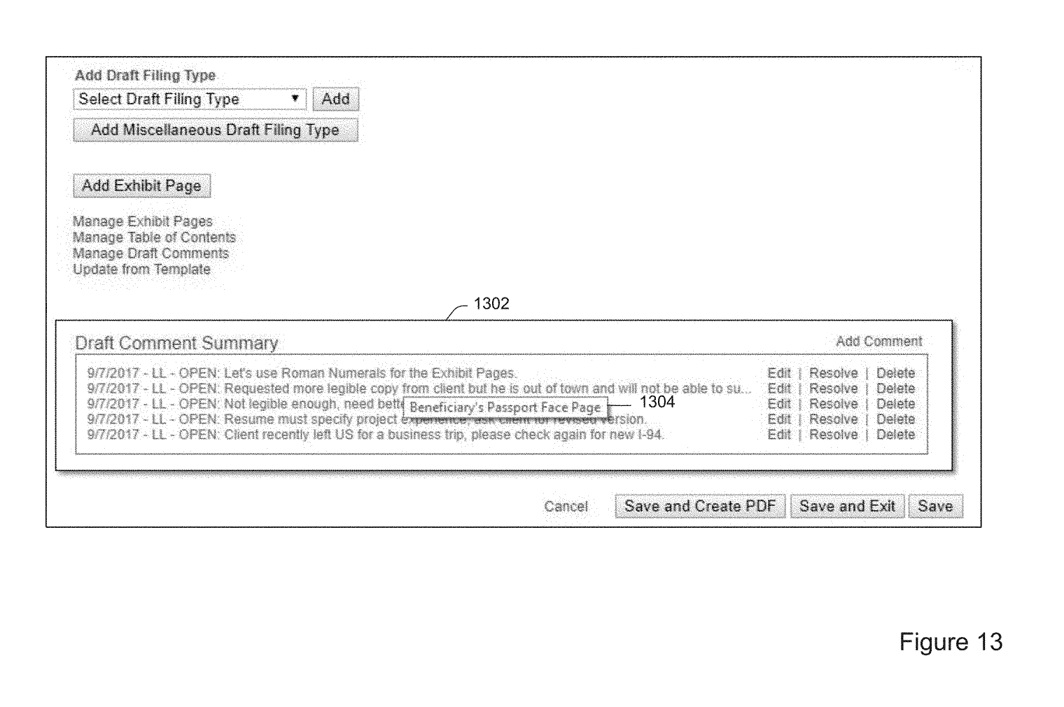

As shown in FIG. 13, a commenting interface may include a draft comment summary 1302 associated with an immigration application based on an immigration application template. For example, the comment summary may be associated with an H-1B visa application. At 1304, a user may observe which draft filing item is associated with a particular comment by hovering a selection tool, such as a cursor, over the comment.

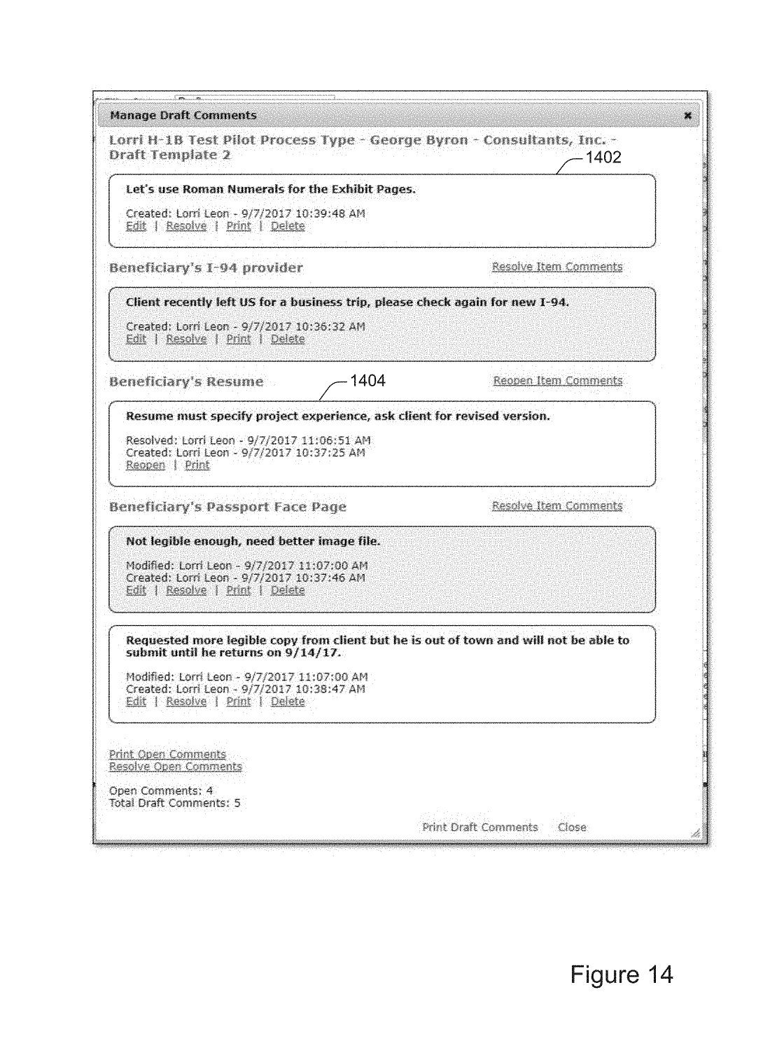

As shown in FIG. 14, a commenting interface may be used to facilitate the review and resolution of reviewer comments for draft filing types associated with one or more immigration application templates. At 1402, a user has options to manage the comment's work flow by performing an action such as editing the comment, deleting the comment, printing the comment, or marking the comment as resolved. At 1404, the user has the option to re-open a comment previously marked as resolved to indicate further action may be required.

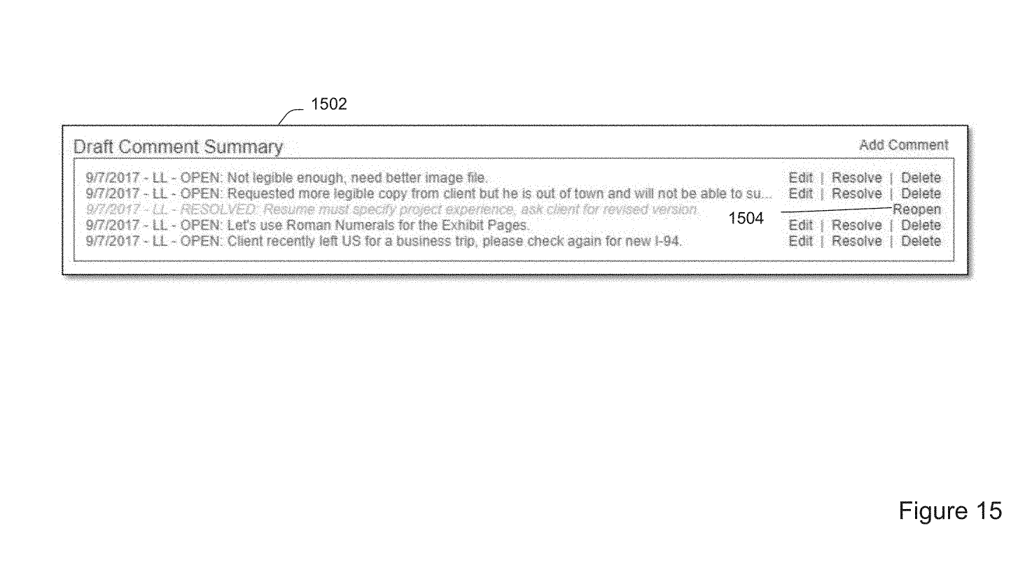

As shown in FIG. 15, a commenting interface may include a list of comments along with status information for each comment. For example, the comment summary may be associated with an H-1B visa application. At 1502, the comment history is displayed for user review. At 1504, a user may reopen a comment that has been previously marked as resolved.

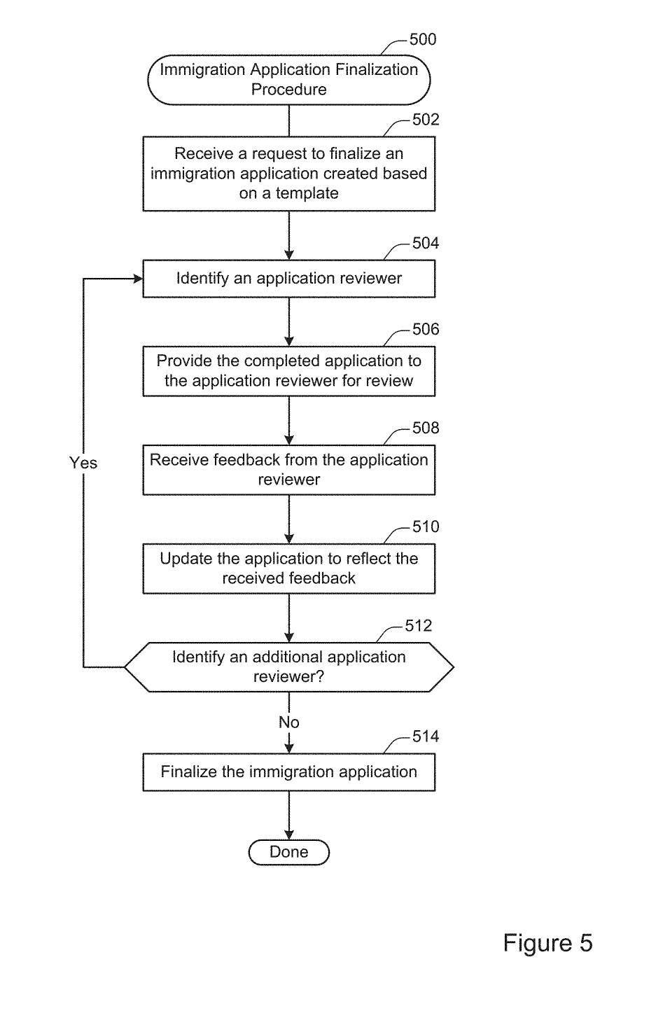

FIG. 5 illustrates an example of an immigration application review procedure 500, performed in accordance with one or more embodiments. According to various embodiments, the procedure 500 may be performed in order to facilitate the review of an immigration application template based on one or more immigration applications. For example, the procedure 500 may be performed to facilitate the review of an H-1B visa application. As another example, the procedure 500 may be performed to facilitate the review of a PERM application. As yet another example, the procedure 500 may be performed to facilitate the review of an O-1 visa application. In some implementations, the procedure 500 may be performed at a server in communication with a client machine. Alternately, the procedure 500 may be performed entirely at a client machine.

As an overview, a request to create an immigration application is received at 500. Then, at 502, a request to finalize an immigration application created based on a template is received. At 504, an application reviewer is identified. At 506, the completed application is provided to the application reviewer for review. At 508, feedback from the application reviewer is received. At 510, the application is updated to reflected the received feedback. At 512, a determination is made as to whether to identify an additional application reviewer. At 514, the immigration application is finalized.

At 502, a request to finalize an immigration application is received. According to various embodiments, the request for review may be made by a user. For example, a user may provide information to the system to create a request for review, such as by assigning a review function to another user in the system, or marking the status of the immigration application as “send for review.” Alternately, or additionally, a request may be created automatically or dynamically. For example, a request may be created automatically or dynamically when an immigration application's status is changed from “draft” to “ready for review.” As another example, a request may be created automatically or dynamically, through an automated detection process that detects the completion rate of the various stages of an immigration application process.

At 504, an application reviewer is identified. According to various embodiments, an application reviewer may be identified by user input, an automated process, or some combination thereof. For example, a user may identify a reviewer associated with an immigration application, such as a company officer, or the company's legal representative. As another example, an automated process may assign a reviewer associated with an immigration application. For instance, for an H-1B visa application, with respect to the job description, an automated process may determine that a reviewer is the petitioner employee's hiring manager, and that another reviewer the company's Director of HR, and identify those individuals based on their user roles in the system.

At 506, the completed application is provided to the application reviewer for review. According to various embodiments, the completed application may be provided to the application reviewer in any of various ways. These may include, but are not limited to: email, other types of messaging services, a web-based portal, and one or more shared documents stored on a storage system.

At 508, feedback from the application reviewer is received. According to various embodiments, the feedback may be obtained by user input. For example, a user may provide text in a blank text field to add notes to a particular document, or to the overall application. As another example, a user may identify errors in a document and provide corrective information to replace the erroneous information.

In some implementations, an automated process may review an immigration application and identify errors. Alternately or additionally, an automated system may provide suggestions for resolving errors. For example, using business logic, an automated process may determine that the wrong government department is associated with a particular draft filing type in a table of contents. The automated process may then provide a suggestion to resolve the error for review by a user.

In particular embodiments, the reviewer may add comments within the draft filing feature that related to specific documents (e.g., draft filing types) that make up the draft filing. Such comments may allow the user that receives the feedback to easily understand which of the reviewer's comments/changes relate to which documents. After the reviewer provides comments, the system may indicate how many open comments/edits there are per document in the draft filing in order to help keep track of changes yet to be finalized.

At 510, the application is updated to reflected the received feedback. In some implementations, a user may update an application with corrective information and replace a previous version of the application with the updated one. Alternately or additionally, an automated process may automatically save new drafts of the application as it is being edited and corrected by a user.

In some embodiments, the updating of an application may be performed by an automated process. For example, the automated process may automatically update formatting errors based on guidelines set by a government form. As another example, the application may be updated through an automated process that updates an application whenever a change is made in information associated with the application stored in a corresponding database.

At 512, a determination is made as to whether to identify an additional application reviewer. In some implementations, a user may identify a reviewer associated with an immigration application, such as a company officer, or the company's legal representative. Alternately or additionally, an automated process may a reviewer associated with an immigration application. For example, for an O-1 visa application, with respect to the job description, an automated process may determine that a reviewer is the petitioner employee's hiring manager, and identify those individuals based on their user roles in the system.

In particular embodiments, an additional application reviewer may be identified if the system determines that one or more outstanding issues are remaining. Alternately, or additionally, an additional application reviewer may be identified if the template or system specifies that a designated number, type, or role of reviewer must review the application prior to finalization.

At 514, the immigration application is finalized. As part of the finalization process, the immigration application template is reviewed by one or more reviewers to evaluate if there is any missing documentation or any unresolved errors. Such reviewers may include, but are not limited to: an automated review process, one or more attorneys, one or more sponsoring organization representatives, and one or more third party reviewers.

In some implementations, as part of the review process, it may be determined that an additional draft filing type may be added to the immigration application template. As an example, it may be determined that a draft filing type in the form of a cover letter may be added to the immigration application template. A user may then select or decline to add an additional draft filing type, and or may edit a previously uploaded draft filing type.

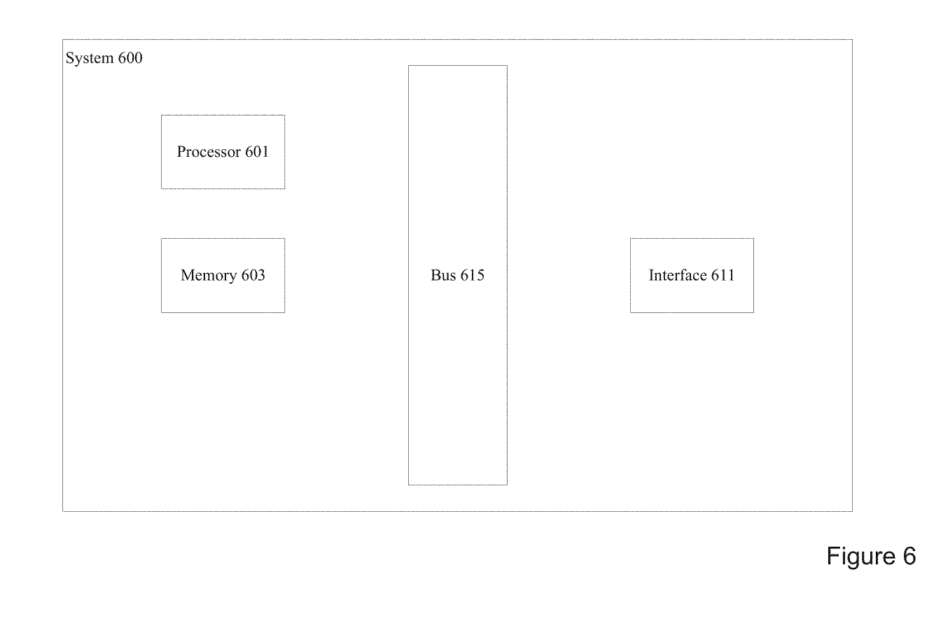

FIG. 6 illustrates one example of a computing device, configured in accordance with one or more embodiments. According to particular embodiments, a system 600 suitable for implementing particular embodiments of the present invention includes a processor 601, a memory 603, an interface 611, and a bus 615 (e.g., a PCI bus or other interconnection fabric).

Particular examples of interfaces supported include baseband interfaces such as SDI, HDMI, DisplayPort, MIPI and the like; and network interfaces such as Ethernet, frame relay, cable, DSL, token ring, and the like. In addition, various very high-speed interfaces may be provided such as Infiniband interfaces, 100 Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

1. A method comprising:
receiving a request to create an immigration application template, the immigration application template corresponding with a designated immigration application type;
at a processor, identifying a plurality of draft filing types to include in the immigration application template, each draft filing type corresponding with a respective one or more pages of an immigration application, each draft filing type identifying information to be included in the immigration application;
at the processor, determining ordering information for the identified draft filing types, the ordering information indicating an order in which information corresponding with the identified draft filing types is included in the immigration application; and
storing the immigration application template on a storage medium.

2. The method recited in claim 1, wherein a first one of the draft filing types corresponds to an official immigration form provided by the United States Citizenship and Immigration Service.

3. The method recited in claim 2, wherein the draft filing type indicates one or more information fields for providing information used to complete the official immigration form.

4. The method recited in claim 3, wherein the draft filing type further indicates a respective database location for one or more of the indicated information fields, the database location storing information suitable for filling the indicated information field.

5. The method recited in claim 1, wherein the immigration application template includes a designated review criterion, the designated review criterion indicating one or more reviewers to review the immigration application created based on the template.

6. The method recited in claim 5, wherein the reviewer includes a machine learning procedure configured to estimate a probability of success for the immigration application.

7. The method recited in claim 6, wherein the machine learning procedure is further configured to identify one or more characteristics of the immigration application to be modified in order to increase the probability of success.

8. The method recited in claim 1, wherein a first one of the draft filing types corresponds to a type of supporting document to be included in the immigration application.

9. The method recited in claim 8, wherein the supporting document includes one or more data fields that may be filled based on user input.

10. The method recited in claim 1, wherein the method further comprises:
identifying a business logic rule to resolve one or more potential errors that may occur when creating the immigration application based on the template, the business logic rule indicating a criterion for identifying an error condition, the business logic rule also indicating a procedure for correcting the identified error condition.

11. A computing device comprising:
a communications interface operable to receive a request to create an immigration application template, the immigration application template corresponding with a designated immigration application type;
a processor operable to:
identify a plurality of draft filing types to include in the immigration application template, each draft filing type corresponding with a respective one or more pages of an immigration application, each draft filing type identifying information to be included in the immigration application, and
determine ordering information for the identified draft filing types, the ordering information indicating an order in which information corresponding with the identified draft filing types is included in the immigration application; and
a storage medium operable to store the immigration application template.

12. The computing device recited in claim 11, wherein a first one of the draft filing types corresponds to an official immigration form provided by the United States Citizenship and Immigration Service.

13. The computing device recited in claim 12, wherein the draft filing type indicates one or more information fields for providing information used to complete the official immigration form.

14. The computing device recited in claim 13, wherein the draft filing type further indicates a respective database location for one or more of the indicated information fields, the database location storing information suitable for filling the indicated information field.

15. The computing device recited in claim 11, wherein the immigration application template includes a designated review criterion, the designated review criterion indicating one or more reviewers to review the immigration application created based on the template.

16. The computing device recited in claim 15, wherein the reviewer includes a machine learning procedure configured to estimate a probability of success for the immigration application.

17. One or more computer readable media having instructions stored thereon for performing a method, the method comprising:
receiving a request to create an immigration application template, the immigration application template corresponding with a designated immigration application type;
at a processor, identifying a plurality of draft filing types to include in the immigration application template, each draft filing type corresponding with a respective one or more pages of an immigration application, each draft filing type identifying information to be included in the immigration application;
at the processor, determining ordering information for the identified draft filing types, the ordering information indicating an order in which information corresponding with the identified draft filing types is included in the immigration application; and
storing the immigration application template on a storage medium.

18. The one or more computer readable media recited in claim 17, wherein a first one of the draft filing types corresponds to an official immigration form provided by the United States Customs and Immigration Service.

19. The one or more computer readable media recited in claim 18, wherein the draft filing type indicates one or more information fields for providing information used to complete the official immigration form.

20. The one or more computer readable media recited in claim 19, wherein the draft filing type further indicates a respective database location for one or more of the indicated information fields, the database location storing information suitable for filling the indicated information field.
